(19) United States
(12) Patent Application Publication
(10) Pub. No.: US 2003/0217996 A1
(43) Pub. Date: Nov. 27, 2003

(54) Method for simultaneous laser beam soldering

(76) Inventors: Hubert De Steur, Drongen (BE); Marcel Heerman, Merelbeke (BE)

Correspondence Address: HARNESS, DICKEY & PIERCE, P.L.C., P.O.BOX 8910, RESTON, VA, 20195, US

(21) Appl. No.: 10/346,358

(22) Filed: Jan. 17, 2003

(30) Foreign Application Priority Data
Mar. 26, 2002 (DE) 10213577.0

(51) Int. Cl. B23K 1/005

(52) U.S. Cl. 219/121.85

(57) ABSTRACT

In order to produce soldered connections between the contacts of components and the associated connections of a support, a deflectable laser beam is aimed at all the soldered points of a component quickly one after another and in a plurality of passes. This is done until the solder has melted at all the soldered points. The energy is supplied in a timesharing procedure, as a result of which more energy can be supplied without the risk of thermal damage, and the processing time can be shortened.

The present application hereby claims priority under 35 U.S.C. §119 on German patent application number 10213577.0 filed Mar. 26, 2002, the entire contents of which are hereby incorporated herein by reference.

### BACKGROUND OF THE INVENTION

Flip-chip contacting is a semiconductor mounting method in which the contacts on the semiconductor component are connected directly to the associated connections of a support, such as a printed circuit board. In order to make this possible, the contacts on the semiconductor component are normally provided with bumps which can be melted or at least wetted by solder. However, bumps of this type can also be formed on the connections of the support, the semiconductor component then only needing flat contacts that can be wetted by solder. In both cases, after the semiconductor component has been positioned on the installation space on the support, all the soldered connections are produced simultaneously in a melting process, for example during a passage through an oven. However, considerable thermomechanical stress loading of both connection partners arises during this connection process.

In addition to flip-chip contacting, to mount semiconductor components and any other desired components on a support, use is also made in particular of surface mounting, in which the SMDs (surface mounted devices) are soldered onto printed circuit boards or ceramic substrates. When the contacts of the SMDs are connected to the associated connections of a support by soldering, similar problems arise as in the case of flip-chip contacting.

In the case of single point laser beam soldering, the solder is melted sequentially with the aid of a laser beam at the soldered points on the components. The advantage in this case is that the amount of energy required for the soldering operation can be introduced in a locally limited and exactly controllable manner. On the other hand, the sequential processing of the individual soldered points cannot be carried out economically, since it takes up too much time. This disadvantage, which is serious in particular when mounting components with a large number of poles, can be avoided by simultaneous laser beam soldering. In this case, all the contacts of a component are soldered at the same time by means of suitable beam shaping.

The advantages of this method as compared with single point laser soldering are the increase in productivity, the utilization of the self-centering effected by the surface tension of the solder, and lower inherent stresses in the soldered connections. In the concept for simultaneous laser beam soldering presented in DE-Z productronic 4/5-1998, pages 24 to 28, the beam shaping is carried out by producing a line of light which, for the purpose of soldering, is positioned transversely across the contacts of a component. A line focus can be produced firstly by the laser radiation being deflected at high speed by a polygonal or scanner mirror and a line of light therefore being produced as a time average. Secondly, the laser radiation can also be shaped by cylindrical lenses to form a line focus. During the mounting of components having two or four rows of contacts, however, two or four lines of light have to be produced simultaneously, which can be implemented only with considerable effort. In addition, during simultaneous laser beam soldering with the aid of lines of light, the regions between the contacts of the components are also irradiated and therefore subjected to high thermal stress.

In a concept disclosed by DE-A-44 46 289 for simultaneous laser beam soldering, an optical waveguide device having at least one optical fiber is provided to transmit the laser radiation. In this case, the final cross section of this optical waveguide device covers the entire region of the soldered points of a component. The optical wave guide device can, however, also comprise a plurality of optical fibers which are arranged in such a way that only the soldered points have laser radiation applied to them. The soldered points can have laser radiation applied to them both through the components to be mounted and through the support, but the latter case being restricted to the use of thin flexible wiring systems as a support.

### SUMMARY OF THE INVENTION

An embodiment of the invention may be based on the problem of providing a method for simultaneous laser beam soldering which can be carried out economically with little effort, ensures qualitatively high-value soldered connections with only little thermal stress on the connecting partners and can be applied to all types of supports.

An embodiment of the invention ma be based on the finding that, by using a single laser beam that can be deflected in two planar directions, the solder can be melted simultaneously at all the soldered points of a component, the rapidly circulating laser spot being aimed only at the soldered points. Since the laser beam is aimed at all the soldered points of a component in a plurality of passes or circuits, the supply of energy to the individual soldered points is carried out in a timesharing procedure, it being possible in each case for an accurately metered amount of energy to be pumped into the individual soldered points. Until the next pulse of energy arrives during the next pass or circuit, this energy can be distributed over the connection of a support and the conductor tracks from said connection, without causing the risk of burning. As a result of the repeated, time-limited and accurately metered supply of the energy to the soldered points, more energy can be supplied and the processing time can be shortened. Rapid soldering is therefore made possible, which to some extent, is carried out synchronously with the placement procedure. The simultaneous melting of the solder at all the soldered points of a component in addition makes a contribution to the self-centering of this component.

The method according to an embodiment of the invention can be applied to all types of support, in particular including lead frames. In addition to flip-chip contacting, the method according to an embodiment of the invention can also be used for the surface mounting of SMDs, it being possible in particular here for SMD types with a large number of poles to be mounted on a support. Since only very little thermal stress on the support material occurs during the soldering procedure, cost-effective materials can be selected.

The term “pass” is intended, in the sense of an embodiment of the present invention, not just to mean a closed circuit during which the laser beam is aimed at adjacent soldered points one after another. The term “pass” is intended also to be understood to mean other movement sequences, for example figure-of-eight paths, if the laser beam is aimed equally frequently at all the soldered points of a component during the individual passes.

A refinement permits even faster mounting of the components, since in each case the shortest path is used for the passes of the laser beam, making optimum use of the time.

A development prevents damaging temperature stress on the materials between the individual soldered points.

Another refinement permits a reduction in the temperature stress on the materials between the individual soldered points.

Still another refinement permits a further reduction in mounting time as a result of the simultaneous mounting of two or more components.

In one embodiment, the laser beam can be aimed at the soldered points through the components. This results in particularly simple guidance of the laser beam. If the wavelength of the laser radiation is in the infrared range, no damage occurs even in the case of semiconductor components.

In one embodiment, the laser beam can be aimed at the soldered points through the support, if a flexible circuit is used as the support. Here, too, the base material of the flexible circuit and the wavelength of the laser radiation should be coordinated with each other in such a way that no damage to the base material occurs.

The use of a diode laser is particularly suitable when acting on the soldered points through the components.

The use of an Nd:YAG laser is suitable when acting on the soldered points through the components or through a support constructed as a flexible circuit.

One development permits particularly fast deflection of the laser beam by using galvanometers to drive the deflection mirror.

### BRIEF DESCRIPTION OF THE DRAWINGS

In the following text, exemplary embodiments of the invention will be explained in more detail using the drawing, in which:

FIG. 1 shows an arrangement for simultaneous laser beam soldering,

FIG. 2 shows the principle of producing flip-chip soldered connections by use of simultaneous laser beam welding with the laser beam being guided through the component,

FIG. 3 shows the arrangement according to FIG. 2 after the flip-chip soldered connections have been finished,

FIG. 4 shows the principle of producing flip-chip soldered connections by means of simultaneous laser beam soldering with the laser beam being guided through a flexible circuit used as a support, and

FIG. 5 shows the principle of the simultaneous mounting of two components by use of simultaneous laser beam soldering.

### DETAILED DESCRIPTION OF THE PREFERRED EMBODIMENTS

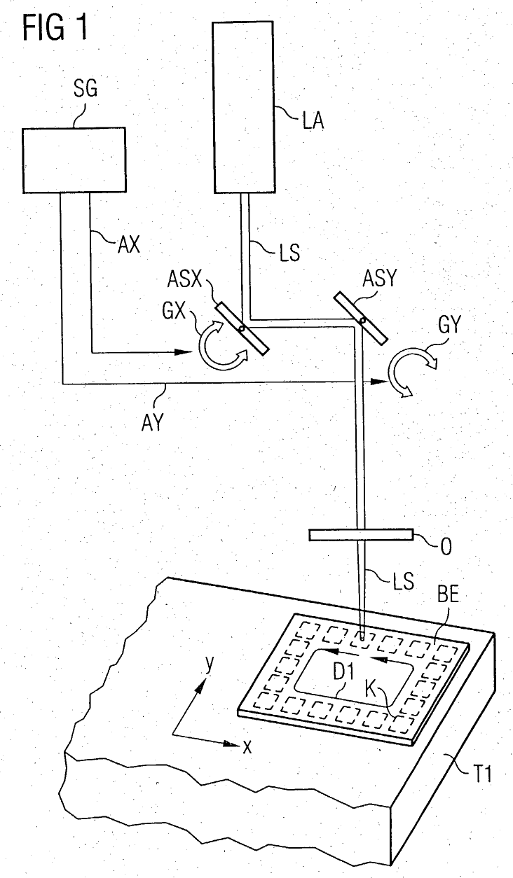

FIG. 1 shows a very simplified schematic representation of an arrangement for mounting a component BE on a support T1 by use of simultaneous laser beam soldering. The arrangement illustrated comprises a laser LA which produces a laser beam LS in whose beam path, one after another, there are arranged a first rotatable deflection mirror ASX, a second rotatable deflection mirror ASY and an objective O, which focuses the laser beam LS onto the contacts K shown dashed on the underside of the component BE. The position of the component BE and of the support T1 is defined with reference to a planar Cartesian x,y coordinate system.

Accordingly, the first deflection mirror ASX has the task of deflecting the laser beam LS in the x direction, while the second deflection mirror ASY has the task of deflecting the laser beam LS in the y direction. The rotation of the deflection mirrors ASX and ASY for deflecting the laser beam LS in the x direction and in the y direction is carried out by galvanometers GX and GY, which are indicated only by appropriate double arrows in FIG. 1, however. The control of the deflection mirrors ASX and ASY in accordance with the respectively desired movement path of the laser beam LS is carried out by means of a control device SG.

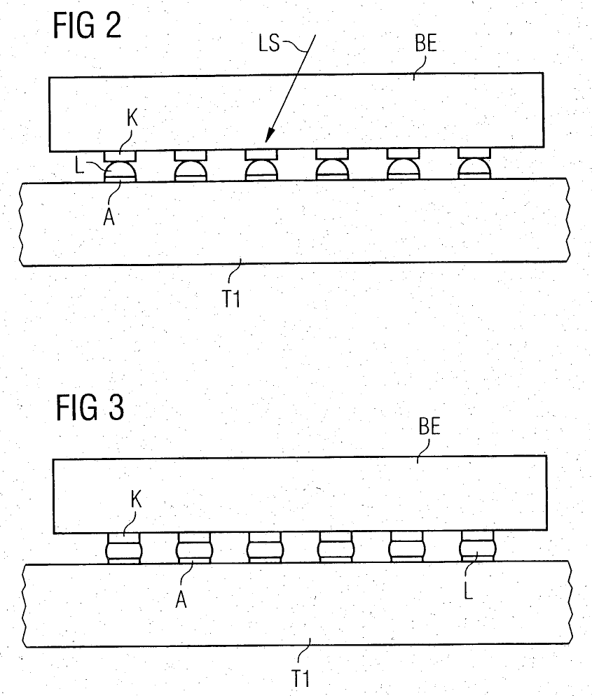

In the exemplary embodiment illustrated, the laser beam LS is guided over the contacts K of the component BE in the counterclockwise direction in a multiple pass. This movement path with the repeated circuit or pass of the laser beam LS is indicated by a line D1 in FIG. 1. The laser beam LS led through the component BE and aimed at a contact K is intended to effect a soldered connection at this point, for whose more detailed explanation reference is additionally made to FIG. 2. The highly simplified section according to FIG. 2 shows that the component BE is to be mounted on the support T1, constructed as a printed circuit board, by means of flip-chip contacting, the contacts K of the component BE and the associated connections A of the support T1 being connected with the aid of solder L.

It can be seen that the solder L is applied in the form of solder bumps or solder domes to the individual connections A of the support T1. Each of the soldered points required for flip-chip contacting therefore comprises a contact K, the associated connection A and the solder L applied in the form of a dome to the connection A. In this case, the contacts K can additionally also be covered with a thin solder layer. Furthermore, it is also possible to introduce the quantity of solder needed for the soldering procedure in the form of solder paste between the contacts K and the associated connections A.

The laser beam LS aimed at a soldered point through the component BE according to FIG. 2 effects heating, although this is initially not yet intended to lead to the solder L melting. Since, during simultaneous laser beam welding, the solder L is to be melted simultaneously at all the soldered points, the laser beam LS is aimed at all the soldered points of the component BE quickly one after another and in a plurality of passes D1 (cf. FIG. 1), until the solder L has melted simultaneously at all the soldered points. After the laser beam LS has been switched off, the solder L then cools down and assumes the form which can be seen from FIG. 3 in the finished flip-chip contacting soldered connections. It can be seen that the solder L has now assumed a more barrel-like form as compared with the dome form illustrated in FIG. 2.

The laser. LA illustrated in FIG. 1 is an Nd:YAG laser, which is operated at wavelengths of 1060 nm or about 1300 nm. At these wavelengths, even components BE constructed as semiconductor components are not damaged during the passage of the laser beam LS. The use of a rugged and inexpensive diode laser at a wavelength of about 800 nm is likewise very advantageous.

The control device SG which effects the guidance of the laser beam LS over all the soldered points in a multiple pass D1, switches the laser beam LS off between the individual soldered points. By this, thermal damage to the material between the individual soldered points can be avoided with certainty. However, it is also possible to guide the laser beam LS in a jumpy manner from soldered point to soldered point, the laser beam LS not stopping during the multiple pass D1 but being moved at very high speed between the individual soldered points. During this procedure, too, thermal damage to the material between the individual soldered points is avoided.

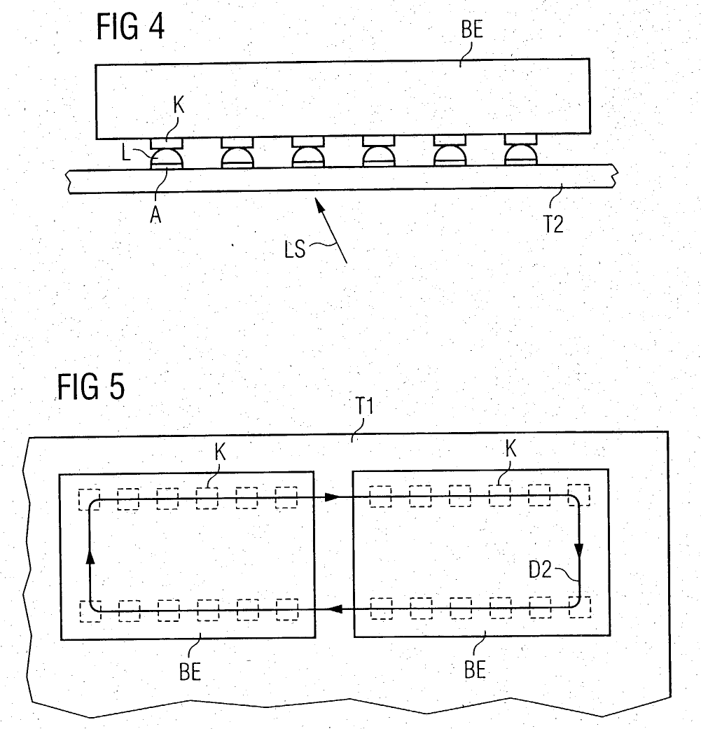

According to FIG. 4, during the flip-chip contacting of components BE on a support T2 constructed as a flexible circuit, the laser beam LS can be aimed at the individual soldered points through the support T2. Otherwise simultaneous laser beam welding is also performed here as in the exemplary embodiment described by using FIGS. 1 to 3. Here, however, the laser LA (cf. FIG. 1) preferably used is an Nd:YAG laser.

FIG. 5 is a plan view of two components BE which are arranged on the support T1 already outlined using FIGS. 1 to 3. The individual soldered points of the two components BE can be seen, in the plan view shown, through the contacts K illustrated dashed on the undersides of the components BE.

For flip-chip contacting of the two components BE, the arrangement illustrated in FIG. 1 is again used. Here, however, the laser beam LS (cf. FIGS. 1 and 2) is guided over the soldered points of both components BE in a plurality of passes until the solder L (cf. FIG. 2) has melted simultaneously at all the soldered points of these two components BE. The corresponding movement path of the laser beam LS is indicated by a line D2 in FIG. 5.

In addition to making simultaneous contact with two components, illustrated in FIG. 5, it is even possible to make contact simultaneously with even more components. However, one precondition is that the components are located within the operating range of the deflection mirrors ASX and ASY (cf. FIG. 1), since only then can the solder at all the soldered points be melted simultaneously. In trials, it has already been possible to mount three components with a large number of poles simultaneously on a printed circuit board.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of producing soldered connections between the contacts of components and the associated connections of a support, comprising:
applying solder to at least one of the contacts and the connections; and
melting solder introduced between the contacts and the connections with the aid of a deflectable laser beam, the deflectable laser beam being aimed at each of the soldered points of a component, one after another and in a plurality of passes, until the solder melts at all the soldered points.

2. The method as claimed in claim 1,wherein the laser beam is guided from one soldered point to a next adjacent soldered point in the direction of movement during each pass.

3. The method as claimed in claim 1, wherein the laser beam is switched off between the individual soldered points.

4. The method as claimed in claim 1, wherein the laser beam is guided in a jumpy manner from soldered point to soldered point, the speed of movement of the laser beam in the region of the soldered points being considerably relatively lower than in the region between the soldered points.

5. The method as claimed in claim 1, wherein the laser beam is guided over the soldered points of at least two components in a plurality of passes, until the solder melts at all the soldered points of the components.

6. The method as claimed in claim 1, wherein the laser beam is aimed at the soldered points through the components.

7. The method as claimed in claim 1, wherein the laser beam is aimed at the soldered points through a support constructed as a flexible circuit.

8. The method as claimed in claim 1, wherein the laser beam is produced with the aid of a diode laser.

9. The method as claimed in claim 1, wherein the laser beam is produced with the aid of an Nd:YAG laser.

10. The method as claimed in claim 1, wherein the laser beam is deflected with the aid of two deflection mirrors, each driven by galvanometers.

11. The method as claimed in claim 1, wherein the solder melts simultaneously at all the soldered points.

12. The method as claimed in claim 2, wherein the laser beam is switched off between the individual soldered points.

13. The method as claimed in claim 2, wherein the laser beam is guided in a jumpy manner from soldered point to soldered point, the speed of movement of the laser beam in the region of the soldered points being considerably relatively lower than in the region between the soldered points.

14. The method as claimed in claim 11, wherein the laser beam is guided over the soldered points of at least two components in a plurality of passes, until the solder melts simultaneously at all the soldered points of the components.

15. The method as claimed in claim 2, wherein the laser beam is aimed at the soldered points through the components.

16. The method as claimed in claim 2, wherein the laser beam is aimed at the soldered points through a support constructed as a flexible circuit.

17. The method as claimed in claim 3, wherein the laser beam is aimed at the soldered points through the components.

18. The method as claimed in claim 3, wherein the laser beam is aimed at the soldered points through a support constructed as a flexible circuit.

19. The method as claimed in claim 11, wherein the laser beam is aimed at the soldered points through the components.

20. The method as claimed in claim 11, wherein the laser beam is aimed at the soldered points through a support constructed as a flexible circuit.

21. The method as claimed in claim 14, wherein the laser beam is aimed at the soldered points through the components.

22. The method as claimed in claim 14, wherein the laser beam is aimed at the soldered points through a support constructed as a flexible circuit.

23. The method as claimed in claim 2, wherein the laser beam is produced with the aid of a diode laser.

24. The method as claimed in claim 2, wherein the laser beam is produced with the aid of an Nd:YAG laser.

25. The method as claimed in claim 2, wherein the laser beam is deflected with the aid of two deflection mirrors, each driven by galvanometers.

26. The method as claimed in claim 3, wherein the laser beam is produced with the aid of a diode laser.

27. The method as claimed in claim 3, wherein the laser beam is produced with the aid of an Nd:YAG laser.

28. The method as claimed in claim 3, wherein the laser beam is deflected with the aid of two deflection mirrors, each driven by galvanometers.
